(19) United States
(12) Patent Application Publication
(10) Pub. No.: US 2018/0357590 A1
(43) Pub. Date: Dec. 13, 2018

(54) PROJECT MANAGEMENT METHOD AND SYSTEM THEREOF

(71) Applicant: National Tsing Hua University, Hsinchu City (TW)

(72) Inventor: Wei-Chang Yeh, Hsinchu (TW)

(73) Assignee: National Tsing Hua University, Hsinchu City (TW)

(21) Appl. No.: 15/729,670

(22) Filed: Oct. 11, 2017

(30) Foreign Application Priority Data
Jun. 8, 2017 (TW) 106119083

(51) Int. Cl. G06Q 10/06

(52) U.S. Cl. CPC G06Q 10/063118; G06Q 10/06313; G06Q 10/067

(57) ABSTRACT

A project management method and a system thereof are provided. The method adapted for a project network model with multiple edges includes following steps: obtaining multiple assignment values of each edge, multiple state distributions corresponding to the assignment values, a connecting configuration between the edges, and an assignment upper bound and a demand level of the project network model; enumerating at least one project path composed of the edges; enumerating at least one critical value assignment vector according to the assignment values of each edge and the assignment upper bound; calculating a project reliability for each critical value assignment vector according to the at least one project path; and, selecting a critical value assignment vector with a maximal project reliability of the at least one critical value assignment vector to perform a value assignment for the project network model.

### CROSS-REFERENCE TO RELATED APPLICATION

This application claims the priority benefit of Taiwan application serial no. 106119083, filed on Jun. 8, 2017. The entirety of the above-mentioned patent application is hereby incorporated by reference herein and made a part of this specification.

### BACKGROUND OF THE INVENTION

### Field of the Invention

The invention relates to a management method, and in particular, a project management method and a system using the same.

### Description of Related Art

Project management has always played an important role in the modern society. Be it governance projects of a government or business projects of a company, project management is required to effectively control a project timeline, a project budget, and other factors. One of the conventional project management techniques is, for example, the program evaluation and review technique (PERT), which uses network diagrams to plan projects and schedule expected project timelines for task items with higher uncertainty. In the program evaluation and review technique or other similar project planning techniques, the network diagram used to plan a project includes edges and nodes. The node represents, for example, a project state such as a number of hours/days for which the project has undergone, and the edge represents, for example, an action or measure taken for the project. In the conventional project management techniques, a network reliability of such project network diagram is often calculated to evaluate the feasibility of various actions or measures in the project.

However, in the conventional calculation method of the network reliability, although the node in the adopted network diagram has multiple states, the edge has only one single state. In the era where technology and networks develop in a rapid manner, this conventional calculation method of the network reliability has indeed limited contribution to the result of project management. Therefore, how to develop a more effective project management method is indeed one of the major issues for people skilled in the art.

### SUMMARY OF THE INVENTION

In light of the above, the invention provides a project management method and a system using this method, wherein the concept of “multi-state distribution” is adopted to calculate a network reliability of a project network as its project reliability for evaluating and selecting a budget assignment method most favorable for the project.

A project management method of an embodiment of the invention is adapted for a project network model with a start node and an end node and a plurality of edges. The project management method includes: obtaining a plurality of assignment values of each of the plurality of edges, a plurality of state distributions respectively corresponding to the plurality of assignment values, a connecting configuration between the plurality of edges, an assignment upper bound of the project network model, and a demand level of the project network model; enumerating at least one project path which is composed of the plurality of edges, starts from the start node, and ends at the end node, according to the state distribution corresponding to a maximal assignment value of the plurality of assignment values of each of the plurality of edges, the connecting configuration, and the demand level; enumerating at least one critical value assignment vector according to the plurality of assignment values of each of the plurality of edges and the assignment upper bound; calculating a project reliability for each critical value assignment vector according to the at least one project path; and selecting a critical value assignment vector with a maximal project reliability of the at least one critical value assignment vector to perform a value assignment for the project network model.

A project management system of an embodiment of the invention is adapted for a project network model with a start node and an end node and a plurality of edges. The project management system includes an input unit, a storage unit, and a processing unit. The input unit is configured to obtain a plurality of assignment values of each of the plurality of edges, a plurality of state distributions respectively corresponding to the plurality of assignment values, a connecting configuration between the plurality of edges, an assignment upper bound of the project network model, and a demand level of the project network model. The storage unit is coupled to the input unit and is configured to store all information obtained by the input unit. The processing unit is coupled to the input unit and the storage unit and enumerates at least one project path which is composed of the plurality of edges, starts from the start node, and ends at the end node, according to the state distribution corresponding to a maximal assignment value of the plurality of assignment values of each of the plurality of edges, the connecting configuration, and the demand level. The processing unit further enumerates at least one critical value assignment vector according to the plurality of assignment values of each of the plurality of edges and the assignment upper bound. The processing unit further calculates a project reliability for each critical value assignment vector according to the at least one project path and selects a critical value assignment vector with a maximal project reliability of the at least one critical value assignment vector to perform a value assignment for the project network model.

In light of the above, in the project management method and the system thereof described in the embodiments of the invention, the project network model is constructed through “multi-state distribution”. In brief, each edge in the project network model includes two or more assignment values representing project actions or project measures corresponding to two or more budgets. This is the concept of “multi-state distribution” different from the prior art. By calculating and comparing the network reliabilities of each edge of the project network model in different state distributions, a project manager learns how to assign budgets for each action or measure in the project in the most favorable manner (e.g., for a better project quality or faster timeline) to enhance the quality of the decision made by the project manager.

To provide a further understanding of the aforementioned and other features and advantages of the invention, exemplary embodiments, together with the reference drawings, are described in detail below.

### BRIEF DESCRIPTION OF THE DRAWINGS

FIG. 1 is a schematic diagram illustrating a project management system according to an embodiment of the invention.

FIG. 2 is a schematic diagram illustrating a project network model processed by a project management system according to an embodiment of the invention.

FIG. 3 is a flowchart illustrating a project management method according to an embodiment of the invention.

FIG. 4 is a flowchart illustrating calculating a project reliability for each critical value assignment vector in a project management method according to an embodiment of the invention.

### DESCRIPTION OF THE EMBODIMENTS

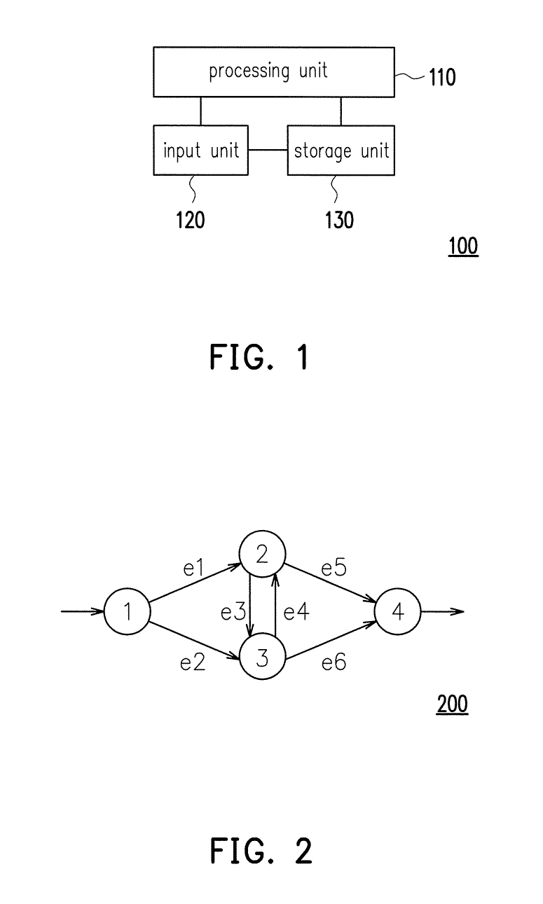

FIG. 1 is a schematic diagram illustrating a project management system according to an embodiment of the invention. Referring to FIG. 1, a project management system 100 includes a processing unit 110, an input unit 120, and a storage unit 130. The processing unit 110 is coupled to the input unit 120 and the storage unit 130, and the storage unit 130 is coupled to the input unit 120.

The input unit 120 includes, for example, input devices such as a keyboard, a mouse, and/or a touch panel. The input unit 120 is configured to receive various information of a project network model inputted by a user, including a connecting configuration between each edge and each node in the project network model, a plurality of assignment values of each edge and a plurality of state distributions respectively corresponding to the assignment values in a one-to-one manner, and an assignment upper bound and a demand level of the project network model.

The storage unit 130 is, for example, a random access memory (RAM) storing the various information of the project network model obtained by the input unit 120. The storage unit 130 is also used to store algorithms, modular programs, or processing procedures relevant to computations in the embodiments of the invention for the processing unit 110 to read and execute.

The processing unit 110 is a central processing unit (CPU), a programmable microprocessor for general or specific purposes, a digital signal processor (DSP), a programmable controller, an application specific integrated circuit (ASIC), another similar device, or a combination of the devices above.

FIG. 2 is a schematic diagram illustrating a project network model processed by a project management system according to an embodiment of the invention. Referring to FIG. 2, a project network model 200 includes 4 nodes and 6 edges in total, wherein a node 1 is a start node and a node 4 is an end node. Each of the edges is directional, and there is a connecting configuration between the edges via the nodes. For example, a direction of an edge e₁ is from the node 1 to a node 2, a direction of an edge e₃ is from the node 2 to a node 3, and the edge e₁ and the edge e₃ are connected to each other.

The project network model 200 represents a procedure of a project from a beginning to an end. Each node represents a state of the project (e.g., a number of hours/days for which the project has undergone). Each edge represents an action or measure taken for the project, wherein each edge includes a plurality of assignment values and a plurality of state distributions corresponding to the assignment values in a one-to-one manner. The assignment value is, for example, a budget required for the action or measure taken for the project as represented by the edge, and the state distribution is, for example, a probability distribution of an impact that the corresponding budget is going to cause on a project state. In a state distribution, there are a plurality of state values and a plurality of corresponding probability values, and a total value of all of the probability values in one single state distribution is 1. Each edge includes a plurality of assignment values, which means that there are a plurality of options in the budget for the action or measure represented by the edge taken for the project. For example, one unit of the budget may be used to purchase an equipment to perform the procedure represented by the edge. Alternatively, two units of the budget may be used to purchase a more expensive and higher-performance equipment to perform the procedure. Moreover, the state distributions corresponding to the one unit of the budget and the two units of the budget are also different. For example, a probability value of using the more expensive and higher-performance equipment to get the project accepted on time is generally higher than a probability value of using a cheaper and mediocre-performance equipment. Each edge has various different state distributions as the assignment values vary, which is the concept of “multi-state distribution” of the invention.

In addition to the foregoing information, the project network model 200 further includes the assignment upper bound and the demand level. The budget available to a project is generally limited, and its upper bound will not be infinitely increased. The assignment upper bound represents such upper bound. This type of project planning/path planning involves the issue of reliability evaluation of a flow network, and the demand level is one of the representative values of this issue. A value of the demand level may be set as a maximal value of the plurality of state values of each state distribution included in the project network model 200, or may be an adequate value set by a user of the project management system.

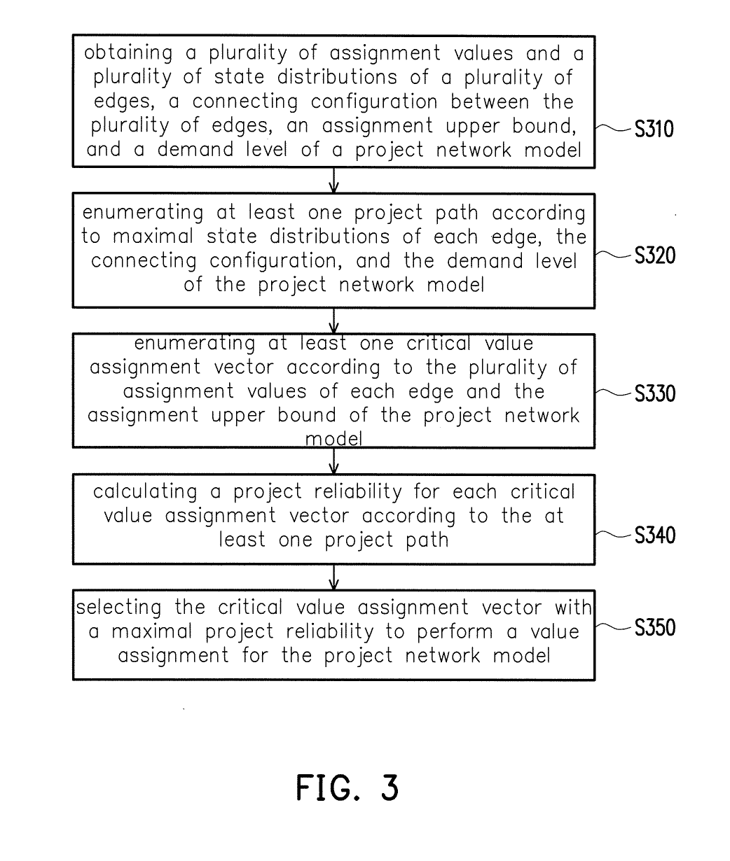

FIG. 3 is a flowchart illustrating a project management method according to an embodiment of the invention. Referring to both FIG. 2 and FIG. 3, in step S310, the input unit 120 receives various information on the project network model 200 inputted by the user, and the information includes: a connecting configuration between each edge in the project network model 200, a plurality of assignment values of each edge and a plurality of state distributions respectively corresponding to the assignment values in a one-to-one manner, and an assignment upper bound and a demand level of the project network model 200. The connecting configuration between each edge is, for example, a direction of an edge stored in a specific data structure, and information of two other edges respectively connected at its start and end nodes. As described above, each state distribution has a plurality of state values and probability values corresponding to each other in a one-to-one manner. The input information above is stored in the storage unit 130 for use in subsequent procedures.

Next, entering from step S310 into step 320, according to maximal state distributions of each edge in the project network model 200, the connecting configuration between each edge and each node, and the demand level of the project network model 200, at least one project path is enumerated. In the data on the project network model 200 inputted by the user, each edge includes a plurality of assignment values and a plurality of state distributions, and the assignment values and the state distributions respectively correspond to each other in a one-to-one manner. The so-called “maximal state distribution” is the state distribution corresponding to a maximal value of the plurality of assignment values. The enumerated project path includes edge state values corresponding to each edge. As described above, in the project network model 200, each state distribution of each edge has a plurality of state values and a plurality of probability values, and the plurality of state values and the plurality of probability values are also in a relationship of one-to-one correspondence. The so-called “edge state value” is any one of the plurality of state values in the state distribution corresponding to the maximal assignment value of the edge, and this value carrot exceed the demand level of the project network model 200. The detailed enumeration method of the project path will be described in detail in later paragraphs of the specification.

Next, entering step S330, at least one critical value assignment vector is enumerated according to the plurality of assignment values of each edge and the assignment upper bound of the project network model 200. The critical value assignment vector includes tuples in a number identical to a number of the edges in the project network model 200. Each of the tuples respectively corresponds to any one of the plurality of assignment values of each edge. If a value of any one tuple is increased to the next-higher assignment value of the corresponding edge, a total value of all of the tuples in the critical value assignment vector will exceed the assignment upper bound of the project network model. In brief, one assignment value is respectively selected from the plurality of assignment values of each edge to form a vector. If any one tuple in the vector is replaced with an assignment value next-higher than the current value in the corresponding edge, and the total value of all of the tuples in the vector exceeds the assignment upper bound of the project network model 200, then this vector is the critical value assignment vector. Specifically, the present embodiment adopts the branch-and-bound technique as the method for enumerating the critical value assignment vectors. Here, another algorithm that achieves the same or similar effect (e.g., the method of exhaustion, which performs more poorly in time complexity but is more intuitive in design) may also be adopted.

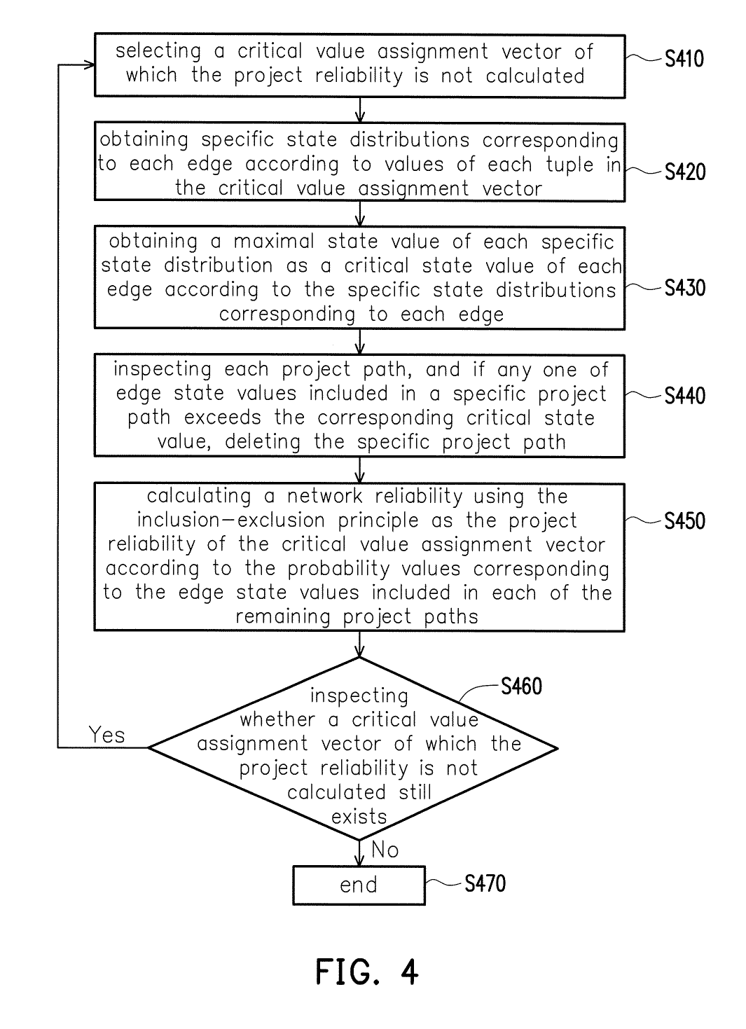

After the critical value assignment vectors are enumerated, entering step S340, according to the enumerated at least one project path, a project reliability is calculated for each of the enumerated critical value assignment vectors. Lastly, entering step S350, the critical value assignment vector with the maximal project reliability is selected to perform a value assignment for the project network model 200. In the following, FIG. 4 will be used to describe a detailed procedure of calculating the project reliability for each of the enumerated critical value assignment vectors according to the enumerated at least one project path in step S340.

FIG. 4 is a flowchart illustrating calculating a project reliability for each critical value assignment vector in a project management method according to an embodiment of the invention. Referring to FIG. 4, in step S410, a critical value assignment vector of which the project reliability is not calculated is selected first. Next, entering step S420, according to the values of each tuple in the critical value assignment vector, specific state distributions corresponding to each edge are obtained. It is known that in the project network model 200, each edge includes a plurality of assignment values and a plurality of state distributions corresponding to the assignment values in a one-to-one manner, and each tuple of the critical value assignment vector respectively corresponds to any one of the plurality of assignment values of each edge. Therefore, on the condition that one of the distribution values of each edge is verified, specific state distributions corresponding to each edge are obtained. In step S430, according to the specific state distributions corresponding to each edge, the maximal state value of each specific state distribution is further used as a critical state value of each edge.

Next, entering step S440, each project path is inspected, and if any one of the edge state values included in a specific project path exceeds the corresponding critical state value, the specific project path is deleted. It shall be noted that the deletion here is merely temporary deletion and is meant to exclude a project path when the project reliability is calculated, if the edge state values of the project path are not consistent with the critical state values of each edge corresponding to the critical value assignment vector. When the project reliability is calculated for other critical value assignment vectors, the edge state values included in all of the project paths are inspected again. Therefore, the project path once excluded from calculation is not necessarily excluded in the calculation for other critical value assignment vectors.

After the project path of which any one edge state value exceeds the corresponding critical state value is deleted, entering step S450, according to the probability values corresponding to the edge state values included in each of the remaining project paths, a network reliability is calculated using the inclusion-exclusion principle and is used as the project reliability of the critical value assignment vector. As described above, the edge state value of the project path is any one of the plurality of state values in the state distribution with the maximal assignment value of the corresponding edge, and the state distribution has a plurality of state values and probability values corresponding to each other in a one-to-one manner. Therefore, on the condition that one state value of one state distribution corresponding to each edge is respectively verified, the probability value corresponding to each edge is obtained, and according to the probability values corresponding to each edge of each project path, the network reliability is calculated using the inclusion-exclusion principle and is used as the project reliability of the critical value assignment vector. The calculation formula is as follows:

$${\sum }_{i = 1}^{p} Pr ( {X}_{i} ) - {\sum }_{j = 2}^{p} {\sum }_{i = 1}^{j - 1} Pr ( {X}_{i} ⋂ {X}_{j} ) + {\sum }_{j = 3}^{p} {\sum }_{i = 2}^{j - 1} {\sum }_{k = 1}^{i - 1} Pr ( {X}_{i} ⋂ {X}_{j} ⋂ {X}_{k} ) + … + {( - 1 )}^{p + 1} Pr ( {X}_{i} ⋂ {X}_{j} ⋂ … ⋂ {X}_{p} )$$

wherein p is a number of the project paths after deletion, Pr(Xᵢ) represents a probability value of an i^{th} project path, Pr(Xᵢ∩Xⱼ) represents a probability value of an intersection of the i^{th} project path and a j^{th} project path, and so on.

Lastly, entering step S460, it is inspected whether a critical value assignment vector of which the project reliability is not calculated still exists. If it does, return to step S410 to repeat the steps above. If it doesn't, it means that the project reliability has been calculated for all of the critical value assignment vectors, and directly entering step S470, the procedure is ended.

To provide a further understanding of the embodiments of the invention, actual data are provided below to detail the project management method of the invention.

In an embodiment of the invention, in step S310, the user first inputs various information of the project network model 200. The information includes assignment values and state distributions of each edge in the project network model 200 presented in Table 1 below. The assignment upper bound is 70, the demand level is 4, and the connecting configuration is the connecting configuration of the plurality of edges and the plurality of nodes as shown in FIG. 2. The information of the assignment values and the state distributions may be obtained from historical data of projects similar to the project corresponding to the project network model 200.

TABLE 1

| | Assignment | State value | | | | |
|---|---|---|---|---|---|---|
| Edge | value | 0 | 1 | 2 | 3 | 4 |
| e₁ | 0 | 0.1 | 0.3 | 0.6 | | |
| | 10 | 0.1 | 0.2 | 0.3 | 0.4 | |
| | 20 | 0.05 | 0.1 | 0.25 | 0.6 | |
| e₂ | 0 | 0.1 | 0.4 | 0.5 | | |
| | 5 | 0.05 | 0.25 | 0.3 | 0.4 | |
| | 10 | 0.03 | 0.2 | 0.37 | 0.4 | |
| | 15 | 0.02 | 0.18 | 0.35 | 0.4 | 0.05 |
| e₃ | 0 | 0.05 | 0.25 | 0.3 | 0.4 | |
| | 10 | 0.03 | 0.2 | 0.37 | 0.4 | |
| e₄ | 0 | 0.05 | 0.25 | 0.3 | 0.4 | |
| | 20 | 0.03 | 0.17 | 0.35 | 0.4 | 0.05 |
| e₅ | 0 | 0.1 | 0.4 | 0.5 | | |
| | 5 | 0.05 | 0.25 | 0.3 | 0.4 | |
| | 10 | 0.05 | 0.2 | 0.35 | 0.4 | |
| | 15 | 0.03 | 0.17 | 0.35 | 0.4 | 0.05 |
| e₆ | 0 | 0.1 | 0.3 | 0.6 | | |
| | 5 | 0.1 | 0.2 | 0.3 | 0.4 | |
| | 10 | 0.05 | 0.1 | 0.25 | 0.5 | 0.1 |

Next, entering step 320, according to the maximal state distribution of each edge, the connecting configuration, and the demand level of the project network model 200, at least one project path is enumerated. According to Table 1, the maximal assignment values corresponding to each edge of the project network model 200 are respectively 20, 15, 10, 20, 15, and 10 from e₁ to e₆. Therefore, by verifying the maximal assignment values of each edge, the maximal state distributions of each edge are obtained as shown in Table 2:

TABLE 2

| | Assignment | State value | | | | |
|---|---|---|---|---|---|---|
| Edge | value | 0 | 1 | 2 | 3 | 4 |
| e₁ | 20 | 0.05 | 0.1 | 0.25 | 0.6 | |
| e₂ | 15 | 0.02 | 0.18 | 0.35 | 0.4 | 0.05 |
| e₃ | 10 | 0.03 | 0.2 | 0.37 | 0.4 | |
| e₄ | 20 | 0.03 | 0.17 | 0.35 | 0.4 | 0.05 |
| e₅ | 15 | 0.03 | 0.17 | 0.35 | 0.4 | 0.05 |
| e₆ | 10 | 0.05 | 0.1 | 0.25 | 0.5 | 0.1 |

According to the maximal state distributions, the connecting configuration, and the demand level (which is 4 in the present embodiment), 20 project paths are enumerated as shown in Table 3 below.

TABLE 3

| X₁ = (0, 4, 0, | X₆ = (1, 3, 0, | X₁₁ = (2, 2, 0, | X₁₆ = (3, 1, 0, |
|---|---|---|---|
| 0, 0, 4) | 0, 1, 3) | 0, 2, 2) | 0, 3, 1) |
| X₂ = (0, 4, 0, | X₇ = (1, 3, 0, | X₁₂ = (2, 2, 0, | X₁₇ = (3, 1, 0, |
| 1, 1, 3) | 1, 2, 2) | 1, 3, 1) | 1, 4, 0) |
| X₃ = (0, 4, 0, | X₈ = (1, 3, 0, | X₁₃ (2, 2, 0, | X₁₈ = (3, 1, 1, |
| 2, 2, 2) | 2, 3, 1) | 2, 4, 0) | 0, 2, 2) |
| X₄ = (0, 4, 0, | X₉ = (1, 3, 0, | X₁₄ = (2, 2, 1, | X₁₉ = (3, 1, 2, |
| 3, 3, 1) | 3, 4, 0) | 0, 1, 3) | 0, 1, 3) |
| X₅ = (0, 4, 0, | X₁₀ = (1, 3, 1, | X₁₅ = (2, 2, 2, | X₂₀ = (3, 1, 3, |
| 4, 4, 0) | 0, 0, 4) | 0, 0, 4) | 0, 0, 4) |

wherein the state value of each edge cannot exceed the demand level, the state values of the edges can be seen as flows, and the relationship with other edges need to satisfy the flow conservation law. For example, in a project path X₂=(0, 4, 0, 1, 1, 3), the state values of the edge e₁ and the edge e₂ extending from the node 1 as the origin are respectively 0 and 4. Based on the connecting configuration shown in the figure, if the state value of the edge e₁ is 0, then the state value of the edge e₃ is definitely 0. The edge e₂ and the edge e₃ converge at the node 3 and then branch into the edge e₄ and the edge e₆. Therefore, a total value of the state values of the edge e₄ and the edge e₆ also needs to be 4. On the other hand, the state value of the edge e₅ should be the state value of the edge e₁ subtracted by the state value of the edge e₃ and then added by the state value of the edge e₄. At this time, the state values of the edge e₁ and the edge e₃ are both 0. Therefore, the state value of the edge e₅ inherits the value of 1 of the edge e₄.

Next, entering step S330, according to the plurality of assignment values of each edge and the assignment upper bound of the project network model 200, the critical value assignment vectors are enumerated using the branch-and-bound technique. In the present embodiment, the assignment upper bound is 70. For example, assignment values 20, 15, 0, 20, 15, 0 are respectively retrieved from the edge e₁ to the edge e₆ to form a vector (20, 15, 0, 20, 15, 0), and a total value of tuples of the vector is 70. The assignment values corresponding to the edge e₁, the edge e₂, the edge e₄, and the edge e₅ are already the maximal assignment values of these edges. Therefore, they cannot be increased to the next-higher assignment values in the edges. The assignment value corresponding to the edge e₃ is 0. If this value is increased to the next-higher assignment value of 10 of the edge e₃, the total value of the tuples of the vector will become 80 and exceeds the assignment upper bound of the project network model 200. The assignment value corresponding to the edge e₆ is 0. If this value is increased to the next-higher assignment value of 5 of the edge e₆, the total value of the tuples of the vector will become 75 and exceeds the assignment upper bound of the project network model 200. Whether the assignment value of any one of the edge e₃ or the edge e₆ is increased to the next-higher assignment value of these edges, all the tuple values of this vector will exceed the assignment upper bound of the project network model 200. Therefore, this vector is a critical value assignment vector. In this step, arrangement made be made from largest to smallest according to the maximal assignment values of each edge, such that the enumeration of the critical value assignment vectors is more intuitive. In the present embodiment, after the assignment values of each edge are ordered, an order in which each tuple in the enumerated critical value assignment vectors corresponds to each edge is (e₁, e₄, e₂, e₅, e₃, e₆), and the critical value assignment vectors as shown in Table 4 below are enumerated:

TABLE 4

| | | |
|---|---|---|
| (20, 20, 15, 15, 0, 0) | (20, 20, 10, 0, 10, 10) | (10, 20, 15, 15, 10, 0) |
| (20, 20, 15, 10, 0, 5) | (20, 20, 5, 15, 10, 0) | (10, 20, 15, 15, 0, 10) |
| (20, 20, 15, 5, 10, 0) | (20, 20, 5, 15, 0, 10) | (10, 20, 15, 10, 10, 5) |
| (20, 20, 15, 5, 0, 10) | (20, 20, 5, 10, 10, 5) | (10, 20, 15, 5, 10, 10) |
| (20, 20, 15, 0, 10, 5) | (20, 20, 5, 5, 10, 10) | (10, 20, 10, 15, 10, 5) |
| (20, 20, 10, 15, 0, 5) | (20, 20, 0, 15, 10, 5) | (10, 20, 10, 10, 10, 10) |
| (20, 20, 10, 10, 10, 0) | (20, 20, 0, 10, 10, 10) | (10, 20, 5, 15, 10, 10) |
| (20, 20, 10, 10, 0, 10) | (20, 0, 15, 15, 10, 10) | (0, 20, 15, 15, 10, 10) |
| (20, 20, 10, 5, 10, 5) | | |

In step S340, the project reliability is calculated for each critical value assignment vector according to at least one project path. Here, a sub-procedure of steps S410 to step S470 is entered. In step S410, a critical value assignment vector of which the project reliability is not calculated is selected. Here, (20, 20, 15, 15, 0, 0) is selected as an example. Next, entering step S420, according to the values of each tuple in the critical value assignment vector, specific state distributions corresponding to each edge are obtained. As described above, each tuple in the selected critical value assignment vector corresponds to each edge in the order of (e₁, e₄, e₂, e₅, e₃, e₆). After being restored to the original order of (e₁, e₂, e₃, e₄, e₅, e₆), it becomes (20, 15, 0, 20, 15, 0). The assignment values corresponding to each edge are 20, 15, 0, 20, 15, 0. According to Table 1, the state distributions corresponding to each edge as shown in Table 5 below are obtained.

TABLE 5

| | Assignment | State value | | | | |
|---|---|---|---|---|---|---|
| Edge | value | 0 | 1 | 2 | 3 | 4 |
| e₁ | 20 | 0.05 | 0.1 | 0.25 | 0.6 | |
| e₂ | 15 | 0.02 | 0.18 | 0.35 | 0.4 | 0.05 |
| e₃ | 0 | 0.05 | 0.25 | 0.3 | 0.4 | |
| e₄ | 20 | 0.03 | 0.17 | 0.35 | 0.4 | 0.05 |
| e₅ | 15 | 0.03 | 0.17 | 0.35 | 0.4 | 0.05 |
| e₆ | 0 | 0.1 | 0.3 | 0.6 | | |

Next, entering step S430, according to the specific state distributions corresponding to each edge, the maximal state values of each specific state distribution are obtained and used as the critical state values of each edge. According to Table 5, the obtained maximal state values corresponding to the edge e₁ to the edge e₆ are (3, 4, 3, 4, 4, 2), which are used as the critical state values of each edge. In step S440, each project path is inspected, and if any one of the edge state values included in a specific project path exceeds the corresponding critical state value, the specific project path is deleted. Here, it is found that the edge state value of 4 corresponding to the edge e₆ in the project path X₁ (0, 4, 0, 0, 0, 4) exceeds the critical state value of 2 of the edge e₆. Therefore, the project path X₁ is deleted. Similarly, a project path X₂ (0, 4, 0, 1, 1, 3), a project path X₆ (1, 3, 0, 0, 1, 3), a project path X₁₀ (1, 3, 1, 0, 0, 4), a project path X₁₄ (2, 2, 1, 0, 1, 3), a project path X₁₅ (2, 2, 2, 0, 0, 4), a project path X₁₉ (3, 1, 2, 0, 1, 3), and a project path X₂₀ (3, 1, 3, 0, 0, 4) are all deleted since the edge state values corresponding to the edge e₆ exceed the critical state value of 2 of the edge e₆. It shall be noted that, as described above, the project paths are merely temporarily deleted in the calculation for the critical value assignment vector (20, 15, 0, 20, 15, 0). When calculations are later performed for other critical value assignment vectors, the edge state values of these project paths and the obtained critical state values of each edge corresponding to other critical value assignment vectors are still compared to determine whether these project paths should be deleted.

Lastly, entering step S450, according to the probability values corresponding to the edge state values included in each of the remaining project paths, the network reliability is calculated using the inclusion-exclusion principle and is used as the project reliability of the critical value assignment vector (20, 15, 0, 20, 15, 0). According to the foregoing calculation formula of the project reliability of the critical value assignment vector, the following project reliability of the critical value assignment vector (20, 15, 0, 20, 15, 0) is obtained: [Pr(X₃)+Pr(X₄)+Pr(X₅)+ . . . +Pr(X₁₈)]−[Pr(X₃∩x₄)+Pr(X₃∩X₅)+ . . . +Pr(X₁₇∩X₁₈)]+[Pr(X₃∩X₄ ∩X₅)+ . . . +Pr(X₁₆∩X₁₇∩X₁₈)]+ . . . −Pr(X₃∩X₄∩X₅∩ . . . ∩X₁₈=0.513354. Here, the calculation for the critical value assignment vector (20, 15, 0, 20, 15, 0) is ended. Next, entering step S460 to inspect whether a critical value assignment vector for which the calculation is not performed still exists. If it does, return to step S410 to proceed with the procedure above. Otherwise, if all of the critical value assignment vectors have undergone the foregoing calculation, enter step S470 and end the sub-procedure.

After the sub-procedure of step S410 to step S470 is ended, returning to step S350, the critical value assignment vector with the maximal project reliability is selected to perform a value assignment for the project network model. Since the procedure is similar to the foregoing steps, the detailed calculations are omitted for ease of description. Lastly, the critical value assignment vector with the maximal project reliability is (20, 0, 15, 15, 10, 10) in Table 4 with a value of 0.688780, which is restored to the original order of (e₁, e₂, e₃, e₄, e₅, e₆) and becomes (20, 15, 10, 0, 15, 10). The assignment values corresponding to each edge are 20, 15, 10, 0, 15, 10. Therefore, values can be assigned for each edge according to the critical value assignment vector. For example, in the project represented by the project network model 200, the budget of 20 units is assigned for the project measure represented by the edge e₁.

In summary of the above, in the project management method and the system thereof described in the embodiments of the invention, the project network model is constructed through “multi-state distribution”. By calculating and comparing the network reliabilities of each edge of the project network model in different state distributions, a decision-making aid most favorable to budget assignment for each action or measure in the project is provided for a project manager to enhance the quality of the decision made by the project manager.

Although the present invention has been described with reference to the above embodiments, it will be apparent to one of ordinary skills in the art that modifications to the described embodiments may be made without departing from the spirit of the invention. Accordingly, the scope of the invention is defined by the attached claims below.

What is claimed is:

1. A project management method adapted for a project network model with a start node and an end node and a plurality of edges, the project management method comprising:
obtaining a plurality of assignment values of each of the plurality of edges, a plurality of state distributions respectively corresponding to the plurality of assignment values, a connecting configuration between the plurality of edges, an assignment upper bound of the project network model, and a demand level of the project network model;
enumerating at least one project path which is composed of the plurality of edges, starts from the start node, and ends at the end node, according to the state distribution corresponding to a maximal assignment value of the plurality of assignment values of each of the plurality of edges, the connecting configuration, and the demand level;
enumerating at least one critical value assignment vector according to the plurality of assignment values of each of the plurality of edges and the assignment upper bound;
calculating a project reliability for each critical value assignment vector according to the at least one project path; and
selecting a critical value assignment vector with a maximal project reliability of the at least one critical value assignment vector to perform a value assignment for the project network model.

2. The project management method according to claim 1, wherein each of the plurality of state distributions comprises a plurality of state values and a plurality of probability values respectively corresponding to the plurality of state values.

3. The project management method according to claim 2, wherein the project path comprises a plurality of edge state values respectively corresponding to each of the plurality of edges, and each of the plurality of edge state values is any one of the plurality of state values included in the corresponding state distribution.

4. The project management method according to claim 3, wherein any one of the plurality of edge state values of the project path does not exceed the demand level.

5. The project management method according to claim 4, wherein the critical value assignment vector comprises tuples in a number identical to a number of the edges, each of the tuples respectively corresponds to any one of the plurality of assignment values of each of the plurality of edges, and if a value of any one of the tuples is increased to a next-higher assignment value of the corresponding edge, a total value of the tuples exceeds the assignment upper bound.

6. The project management method according to claim 5, wherein the step of calculating the project reliability for each critical value assignment vector according to the at least one project path comprises:
obtaining a specific state distribution corresponding to each of the plurality of edges according to the values of each of the tuples of the critical value assignment vector;
obtaining a critical state value of each of the plurality of edges according to the specific state distribution, the critical state value being a value of a maximal state value of the plurality of state values of the specific state distribution;
inspecting each of the at least one project path, and if any one of the plurality of edge state values corresponding to each of the plurality of edges included in a specific project path exceeds the corresponding critical state value, deleting the specific project path; and
calculating a network reliability using the inclusion-exclusion principle as the project reliability of the critical value assignment vector according to the probability values corresponding to the plurality of edge state values corresponding to each of the plurality of edges included in each of the remaining project paths.

7. A project management system adapted for a project network model with a start node and an end node and a plurality of edges, the project management system comprising:
an input unit configured to obtain a plurality of assignment values of each of the plurality of edges, a plurality of state distributions respectively corresponding to the plurality of assignment values, a connecting configuration between the plurality of edges, an assignment upper bound of the project network model, and a demand level of the project network model;
a storage unit coupled to the input unit and storing the plurality of assignment values of each of the plurality of edges, the plurality of state distributions respectively corresponding to the plurality of assignment values, the connecting configuration, the assignment upper bound, and the demand level obtained by the input unit; and
a processing unit coupled to the input unit and the storage unit, the processing unit enumerating at least one project path which is composed of the plurality of edges, starts from the start node, and ends at the end node, according to the state distribution corresponding to a maximal assignment value of the plurality of assignment values of each of the plurality of edges, the connecting configuration, and the demand level, wherein
the processing unit enumerates at least one critical value assignment vector according to the plurality of assignment values of each of the plurality of edges and the assignment upper bound,
the processing unit calculates a project reliability for each critical value assignment vector according to the at least one project path, and
the processing unit selects a critical value assignment vector with a maximal project reliability of the at least one critical value assignment vector to perform a value assignment for the project network model.

8. The project management system according to claim 7, wherein each of the plurality of state distributions comprises a plurality of state values and a plurality of probability values respectively corresponding to the plurality of state values.

9. The project management system according to claim 8, wherein the project path comprises a plurality of edge state values respectively corresponding to each of the plurality of edges, and each of the plurality of edge state values is any one of the plurality of state values included in the corresponding state distribution.

10. The project management system according to claim 9, wherein any one of the plurality of edge state values of the project path does not exceed the demand level.

11. The project management system according to claim 10, wherein the critical value assignment vector comprises tuples in a number identical to a number of the edges, each of the tuples respectively corresponds to any one of the plurality of assignment values of each of the plurality of edges, and if a value of any one of the tuples is increased to a next-higher assignment value of the corresponding edge, a total value of the tuples exceeds the assignment upper bound.

12. The project management system according to claim 11, wherein the step of calculating the project reliability for each critical value assignment vector by the processing unit according to the at least one project path comprises:
obtaining a specific state distribution corresponding to each of the plurality of edges by the processing unit according to the values of each of the tuples of the critical value assignment vector;
obtaining a critical state value of each of the plurality of edges by the processing unit according to the specific state distribution, the critical state value being a value of a maximal state value of the plurality of state values of the specific state distribution;
inspecting each of the at least one project path by the processing unit, and if any one of the plurality of edge state values corresponding to each of the plurality of edges included in a specific project path exceeds the corresponding critical state value, deleting the specific project path; and
calculating a network reliability using the inclusion-exclusion principle by the processing unit as the project reliability of the critical value assignment vector according to the probability values corresponding to the plurality of edge state values corresponding to each of the plurality of edges included in each of the remaining project paths.
